(19) United States
(12) Patent Application Publication
(10) Pub. No.: US 2009/0052168 A1
(43) Pub. Date: Feb. 26, 2009

(54) Artwork of light-emitting display ornament

(76) Inventor: Wen-Chih Chen, Linkou (TW)

Correspondence Address: TROXELL LAW OFFICE PLLC, SUITE 1404, 5205 LEESBURG PIKE, FALLS CHURCH, VA, 22041, US

(21) Appl. No.: 11/892,255

(22) Filed: Aug. 21, 2007

(51) Int. Cl. F21V 33/00; F21V 1/00; F21V 5/00

(52) U.S. Cl. 362/122; 362/237; 362/311

(57) ABSTRACT

An artwork of light-emitting display ornament for use in a ceiling lamp, palace lamp, wall lamp, desk lamp, floor lamp, or pot plant-shaped lighting fixture is disclosed to include a bionic-shaped light-transmissive solid member made out of a light-transmissive stone or fogged glass in the shape of a fruit of flower bud and having a ball hole, and a light emitting diode mounted in the ball hole and controllable to emit light through the bionic-shaped light-transmissive solid member.

### BACKGROUND OF THE INVENTION

1. Field of the Invention

The present invention relates to an artwork and more particularly, to an artwork of light-emitting display ornament, which can be used in a ceiling lamp, palace lamp, wall lamp, desk lamp, floor lamp, pot plant-shaped lighting fixture, etc.

2. Description of the Related Art

People usually will decorate their houses with ornamental devices. Decorating an indoor space with display ornaments makes the indoor space attractive. Regular display ornaments include still ornaments and motion ornaments. Artworks such as sculptures, dolls, models, and etc. are still ornaments. It will soon become boring to have a still display ornament be placed on one place for long.

A traditional artwork is a device for display in a still manner. In order to attract people, lighting may be joined with display ornaments. A lighting artwork is known comprising a light-emitting holder, which holds a light source, and an ornamental device made out of acrylic and set to surround the light-emitting holder. The light source can be a lamp bulb or light emitting diode. When the light source in the light-emitting holder is turned on, the light of the light source goes through the acrylic ornamental device, producing a visual effect.

There is also known an artwork of lighting fixture, which is made in the shape of a pot plant. This pot plant-like artwork of lighting fixture comprises a plurality of fruit-shaped or flower bud-shaped ornaments injection-molded from plastics, and a light source mounted in each of the fruit-shaped or flower bud-shaped ornaments. When the light source in each fruit-shaped or flower bud-shaped ornament is turned on, the fruit-shaped or flower bud-shaped ornaments are illuminated, providing a visual effect. Because the fruit-shaped or flower bud-shaped ornaments are injection-molded from plastics, they do not show the quality of flood lighting when illuminated. Therefore, this pot plant-like artwork of lighting fixture still cannot provide a very attractive visual effect.

### SUMMARY OF THE INVENTION

The present invention has been accomplished under the circumstances in view. It is therefore the main object of the present invention to provide an artwork of light-emitting display ornament, which is bionic-shaped and, which produces a flood lighting effect.

According to one aspect of the present invention, the artwork of light-emitting display ornament comprises a bionic-shaped light-transmissive solid member having a ball hole, and a light emitting diode mounted in the ball hole of the bionic-shaped light-transmissive solid member and controllable to emit light through the bionic-shaped light-transmissive solid member. When the light emitting diode is turned on to emit light through the bionic-shaped light-transmissive solid member, a flood lighting effect is produced.

According to another aspect of the present invention, the bionic-shaped light-transmissive solid member is made out of a light-transmissive, non-homogeneous material.

According to still another aspect of the present invention, the light-transmissive, non-homogeneous material can be a natural stone material, artificial stone-like material, or fogged glass.

According to still another aspect of the present invention, the natural stone material is a stone, and the artificial stone-like material is a poly material.

According to still another aspect of the present invention, the bionic-shaped light-transmissive solid member has the shape of a fruit.

According to still another aspect of the present invention, the bionic-shaped light-transmissive solid member has the shape of a flower bud.

According to still another aspect of the present invention, the bionic-shaped light-transmissive solid member can be tightly fitted into the ball hole of the bionic-shaped light-transmissive solid member or bonded to the ball hole of the bionic-shaped light-transmissive solid member with a glue.

When the light emitting diode is turned on to emit light, light rays from the light emitting diode pass through the light-transmissive, non-homogeneous material of the bionic-shaped light-transmissive solid member, producing a flood lighting effect. Thus, the bionic-shaped light-transmissive solid member is illuminated, causing a sense of beauty that attracts people's eyes.

### BRIEF DESCRIPTION OF THE DRAWINGS

FIG. 1 is a schematic view showing the structure of an artwork of display ornament in accordance with the present invention.

FIG. 2 is a schematic drawing showing one application example of the present invention.

FIG. 3 is a schematic drawing showing another application example of the present invention.

### DETAILED DESCRIPTION OF THE PREFERRED EMBODIMENT

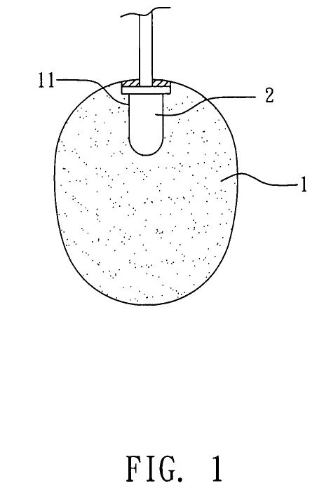

Referring to FIG. 1, an artwork of display ornament in accordance with the present invention is shown comprising a bionic-shaped light-transmissive member 1, and a LED (light emitting diode) 2 mounted in the light-transmissive member 1.

The bionic-shaped light-transmissive member 1 is made out of a light-transmissive, non-homogeneous material, such as natural stone material, artificial stone-like material, or fogged glass. The natural stone material can be a stone. The artificial stone-like material can be a poly material. Preferably, the bionic-shaped light-transmissive member 1 is made out of a natural stone. The light-transmissive member 1 is a solid member processed through a grinding or molding process, showing the shape of a natural object, for example, a piece of grape. The light-transmissive member 1 has a ball hole 11 at the top side for accommodating the LED 2.

After insertion of the LED 2 into the ball hole 11 of the bionic-shaped light-transmissive member 1, a bonding agent, for example, acrylic glue is applied to the ball hole 11 to bond the LED 2 to the bionic-shaped light-transmissive member 1. Alternatively, the ball hole 11 can be made subject to the dimension of the LED 2 so that the LED 2 can be tightly fitted into the ball hole 11.

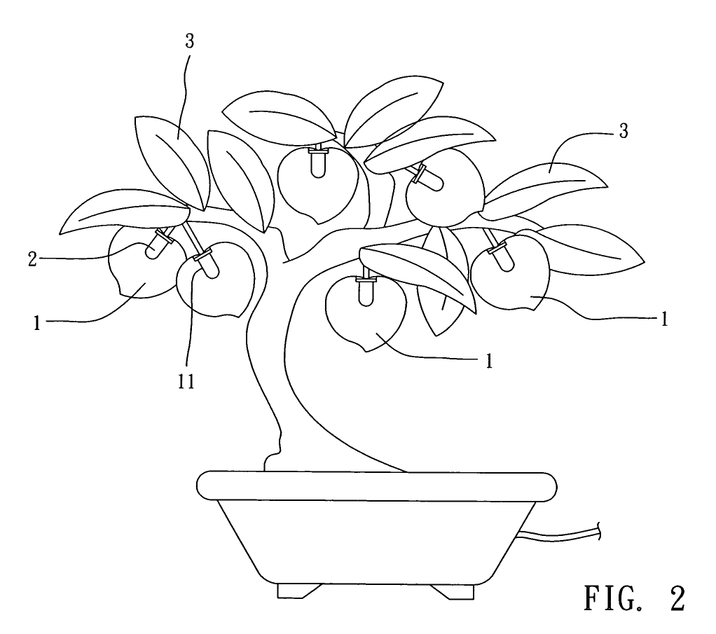

Referring to FIG. 2, multiple display ornaments of the present invention can be used to construct an artificial pot plant. The bionic-shaped light-transmissive members 1 of the display ornaments show the shape of the fruits of a plant, for example, peach. Other ornamental elements, for example, leaf-like ornaments 3 are fastened to the branches of the artificial pot plant. This artificial pot plant is used as a desk lamp, showing a unique sense of beauty.

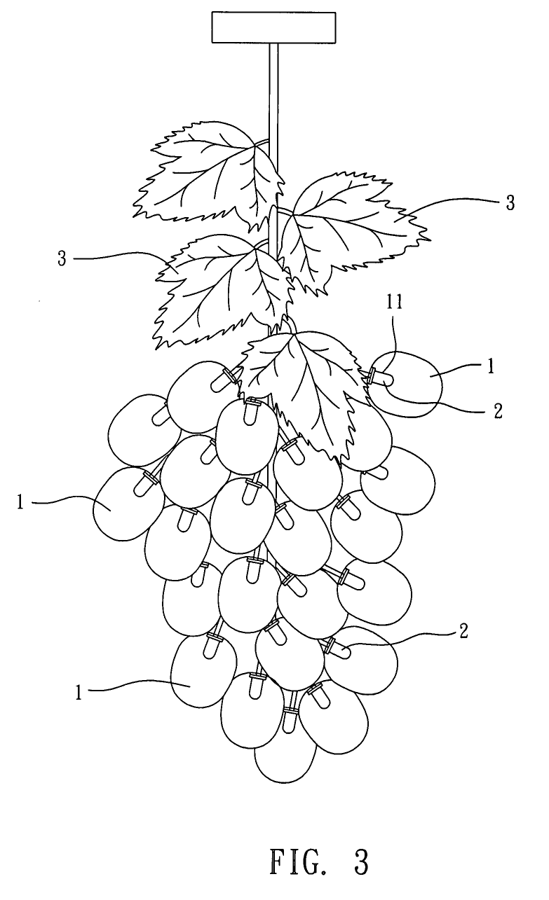

FIG. 3 shows another application example of the present invention. According to this embodiment, multiple display ornaments are used and fastened together to show the shape of a bunch of grapes. This artificial bunch of grapes is constructed with leaf-like ornaments 3 to form a ceiling lamp in which the LEDs 2 of the display ornaments are electrically coupled to an electrical line that is connected to power source.

In actual practice, the bionic-shaped light-transmissive member 1 can be made in any of a variety of other natural objects such as flower bud or the like.

The display ornament of the present invention can be used in a ceiling lamp, palace lamp, wall lamp, desk lamp, floor lamp, pot plant-shaped lighting fixture, etc.

According to the present invention, when the LED of the display ornament is turned on to emit light, the light rays pass through the non-homogeneous material of the light-transmissive member, thereby providing a flood lighting effect to attract people. Further, a lamp made according to the present invention has the shape of a grapevine, pot plant, or any of a variety of natural object. When the LEDs of the display ornaments of the lamp are turned on to emit light, the lamp shows a fantastic visual effect that attracts people's eyes.

Although a particular embodiment of the invention has been described in detail for purposes of illustration, various modifications and enhancements may be made without departing from the spirit and scope of the invention.

What is claimed is:

1. An artwork of light-emitting display ornament comprising a bionic-shaped light-transmissive solid member, said bionic-shaped light-transmissive solid member having a ball hole, and a light emitting diode mounted in the ball hole of said bionic-shaped light-transmissive solid member and controllable to emit light through said bionic-shaped light-transmissive solid member.

2. The artwork of light-emitting display ornament as claimed in claim 1, wherein said bionic-shaped light-transmissive solid member is made out of a light-transmissive, non-homogeneous material.

3. The artwork of light-emitting display ornament as claimed in claim 2, wherein said light-transmissive, non-homogeneous material is selected from one the materials of natural stone material, artificial stone-like material, and fogged glass.

4. The artwork of light-emitting display ornament as claimed in claim 3, wherein said natural stone material is a stone, and said artificial stone-like material is a poly material.

5. The artwork of light-emitting display ornament as claimed in claim 1, wherein said bionic-shaped light-transmissive solid member has the shape of a fruit.

6. The artwork of light-emitting display ornament as claimed in claim 1, wherein said bionic-shaped light-transmissive solid member has the shape of a flower bud.

7. The artwork of light-emitting display ornament as claimed in claim 1, wherein said bionic-shaped light-transmissive solid member is tightly fitted into the ball hole of said bionic-shaped light-transmissive solid member.

8. The artwork of light-emitting display ornament as claimed in claim 1, wherein said bionic-shaped light-transmissive solid member is fixedly bonded to the ball hole of said bionic-shaped light-transmissive solid member with a glue.
